(19) United States
(12) Patent Application Publication
(10) Pub. No.: US 2013/0288199 A1
(43) Pub. Date: Oct. 31, 2013

(54) COMPOSITE REGENERATION MEMBRANE

(71) Applicant: SHIH-CHENG WEN, NEW TAIPEI CITY (TW)

(72) Inventor: SHIH-CHENG WEN, NEW TAIPEI CITY (TW)

(21) Appl. No.: 13/721,531

(22) Filed: Dec. 20, 2012

(30) Foreign Application Priority Data
Apr. 27, 2012 (TW) 101207915

(51) Int. Cl. A61C 19/06; A61C 8/00

(52) U.S. Cl. CPC A61C 19/063; A61C 8/00
USPC 433/173; 433/217.1

(57) ABSTRACT

A composite regeneration membrane is utilized for separating an alveolar bone tissue and a gum epithelium tissue. The composite regeneration membrane comprises a collagen resorbable layer and a titanium bendable layer. The collagen resorbable layer is utilized for transmitting material between the alveolar bone tissue and the gum epithelium tissue. The titanium bendable layer is located in the collagen resorbable layer for supporting the collagen resorbable layer. The titanium bendable layer also has a plurality of transmitting holes allowing the material transmitted by the collagen resorbable layer to pass through.

### FIELD OF THE INVENTION

This invention relates to a regeneration membrane, and more particularly relates to a composite regeneration membrane integrating a resorbable regeneration membrane and a nonresorbable regeneration membrane.

### BACKGROUND OF THE INVENTION

Guided bone regeneration (GBR) is a commonly used dental surgical procedure utilized for guiding the regeneration of periodontal tissues such as alveolar bone to have the periodontal tissue recovery to a better condition to facilitate following dental surgery such as dental implant surgery. In order to prevent the growth of gum epithelium tissue migrating into the damaged area of the alveolar bone, it is commonly used to place a barrier membrane (or regeneration membrane) between the gum epithelium tissue and the alveolar bone tissue during this dental surgical procedure to give more recovery time for the alveolar bone tissue and to assist regeneration of the alveolar bone by using artificial bone grafts to fill the damaged area of the alveolar bone.

Conventional regeneration membranes can be roughly sorted into two types, the resorbable regeneration membrane and the nonresorbable regeneration membrane. The resorbable regeneration membrane is mainly composed of collagen. The advantage of using resorbable regeneration membrane is that a second-step surgery to remove the regeneration membrane is not necessary because collagen might be absorbed over time when being placed in the human body, and the blood circulation between tissues can be maintained because of good permeability of blood. The disadvantage of resorbable regeneration membrane is that the resorbable regeneration membrane cannot provide sufficient support, is difficult to manipulate, and lacks the ability of keeping space for the growth of alveolar bone. In addition, the resorbable regeneration membrane is often absorbed by human body before the completion of growth of alveolar bone such that the predicted function might not be achieved.

Most of the nonresorbable regeneration membranes are mainly composed of Gore-tex, Titanium, or e_PTFE. In contrast with the resorbable regeneration membrane, the advantage of nonresorbable regeneration membrane is that the nonresorbable regeneration membrane is easy to manipulate and has better ability of keeping space for the growth of gum tissue. In addition, these materials would not induce unwanted side effects easily when being placed into human body for a long time. The disadvantages of nonresorbable regeneration membrane is that when doing guided bone regeneration surgery using such regeneration membranes, the open wound is more likely to be infected to result in poor outcome. In detail, because regeneration of alveolar bone needs good circulation of blood, the nonresorbable regeneration membrane isolates not only the gum epithelium tissue but also partially the blood supply for the alveolar bone tissue to slow down the regeneration speed of the alveolar bone tissue. Meanwhile, the poor circulation of blood is also likely to result in flap atrophy to have the wound exposed and being inflected easily. In addition, the second-step surgery is needed to remove the nonresorbable regeneration membrane for the following dental implant procedure.

Four factors must be fulfilled for a successful GBR surgery, they are: (1) a good sealing effect for wound, (2) maintaining a good blood supply, (3) a regeneration membrane capable to maintain growing space, and (4) a regeneration membrane with good stability.

(1) A good sealing effect for wound: the wound should be perfectly stitched up to prevent the damaged area of the alveolar bone and the filled artificial bone powder from being exposed to result in infection. Thus, the regeneration membrane should have the character of good biocompatibility to drive the gum epithelium tissue and make the wound healing quickly. The resorbable regeneration membrane can satisfy this factor.

(2) Maintaining a good blood supply: regeneration speed of alveolar bone tissue would be slow down without a sufficient blood supply, and the gum epithelium tissue is the major blood source for the alveolar bone tissue. By using the resorbable regeneration membrane with good permeability, a good circulation of blood can be achieved. In contrast, the nonresorbable regeneration membrane is worse in this aspect and the blood might not be supplied to the alveolar bone tissue through the membrane.

(3) A regeneration membrane capable to maintain growing space: the regeneration membrane should leave an adequate space for the growth of alveolar bone. The resorbable regeneration membrane cannot fulfill this factor because it might be easily absorbed by human body and is difficult to manipulate to maintain the space. In contrast, the nonresorbable regeneration membrane does not have this disadvantage.

(4) A regeneration membrane with high stability: it would be difficult to have the bone cells adhere to the barrier membrane for regeneration of alveolar bone if the barrier membrane cannot be firmly fixed at the same location. The resorbable regeneration membrane has poor stability because it is softer and easier to slide. In contrast, the nonresorbable regeneration membrane does not have this disadvantage because it is harder and can be fixed by using bone fixation.

In conclusion, both the usages of the resorbable regeneration membrane and the nonresorbable regeneration membrane have some disadvantages and cannot fulfill all the four factors. Thus, there exists a poor outcome for the GBR surgery.

### BRIEF SUMMARY OF INVENTION

The technical problem to be resolved and the object of the present invention:

Thus, it is a main object of the present invention to provide a regeneration membrane, especially a composite regeneration membrane, which combines the advantages of the resorbable regeneration membrane and the nonresorbable regeneration membrane and is capable to fulfill all the four factors, a good sealing effect for wound, maintaining a good blood supply, a regeneration membrane capable to maintain growing space, and a regeneration membrane with good stability, demanded for the GBR surgery, such that the problem of poor outcomes for the conventional regeneration surgery can be resolved.

The technical feature of the present invention for solving the problem:

To resolve the problem of conventional method, a composite regeneration membrane is provided. The composite regeneration membrane is utilized for separating an alveolar bone tissue and a gum epithelium tissue, and comprises a collagen resorbable layer and a titanium bendable layer. The collagen resorbable layer is utilized for transmitting material between the alveolar bone tissue and the gum epithelium tissue. The titanium bendable layer is located in the collagen resorbable layer for supporting the collagen resorbable layer. The titanium bendable layer also has a plurality of transmitting holes allowing the material transmitted by the collagen resorbable layer to pass through.

As a preferred embodiment, the titanium bendable layer further has a main fixing hole for allocating a dental implant, and a diameter of the main fixing hole is greater than that of the transmitting holes. It is also preferred that an interval of the transmitting holes is greater than a predetermined interval for inserting a plurality of bone fixations therebetween to have the composite regeneration membrane fixed on the alveolar bone tissue.

In accordance with another preferred embodiment, a composite regeneration membrane is provided for separating an alveolar bone tissue and a gum epithelium tissue. The composite regeneration membrane includes a collagen resorbable layer and a titanium bendable net. The collagen resorbable layer is utilized for transmitting material between the alveolar bone tissue and the gum epithelium tissue. The titanium bendable net is located in the collagen resorbable layer for supporting the collagen resorbable layer, and meshes of the titanium bendable net are utilized for allowing the material transmitted by the collagen resorbable layer to pass through.

In accordance with a preferred embodiment of the present invention, each node of the titanium bendable net has a fixing part, and the fixing part is disk-shaped. It is preferred to have a fixing hole formed at each node of the titanium bendable net for allocating a bone fixation therethrough to have the composite regeneration membrane fixed on the alveolar bone tissue.

In another preferred embodiment of the present invention, the titanium bendable net further has a main fixing hole formed therein for allowing a dental implant allocated there through and a diameter of the main fixing hole is greater than that of the meshes.

The improvement of the present invention in compared with the prior art:

In compared with the conventional resorbable regeneration membrane and the nonresorbable regeneration membrane, the present invention has the titanium bendable layer assembled in the collagen resorbable layer to enhance rigidity of the regeneration membrane, and the titanium bendable layer also has a plurality of holes formed therein to maintain blood circulation between the gum epithelium tissue and the alveolar bone tissue. In addition, with the main fixing hole formed therein to provide the implanting space for the following dental implant, a second-stage surgery for removing the composite regeneration membrane is not needed such that a better surgery outcome can be achieved.

The embodiments adopted in the present invention would be further discussed by using the flowing paragraph and the figures for a better understanding.

### BRIEF DESCRIPTION OF THE DRAWINGS

FIG. 1 is a structural schematic view of a composite regeneration membrane in accordance with a preferred embodiment of the present invention.

FIG. 2 is a schematic view showing the usage of the composite regeneration membrane in accordance with the present invention.

FIG. 3 is a schematic view showing a composite regeneration membrane in accordance with another preferred embodiment of the present invention.

FIG. 4 is an enlarged view showing area A of the composite regeneration membrane of another embodiment of the present invention.

### DETAILED DESCRIPTION OF THE INVENTION

There are various embodiments of the composite regeneration membrane in accordance with the present invention, which are not repeated hereby. Only two preferred embodiments are mentioned in the following paragraph as an example. It should be understood by those skilled in the art that the preferred embodiments disclosed in the following paragraph are merely an example instead of restricting the scope of the invention itself.

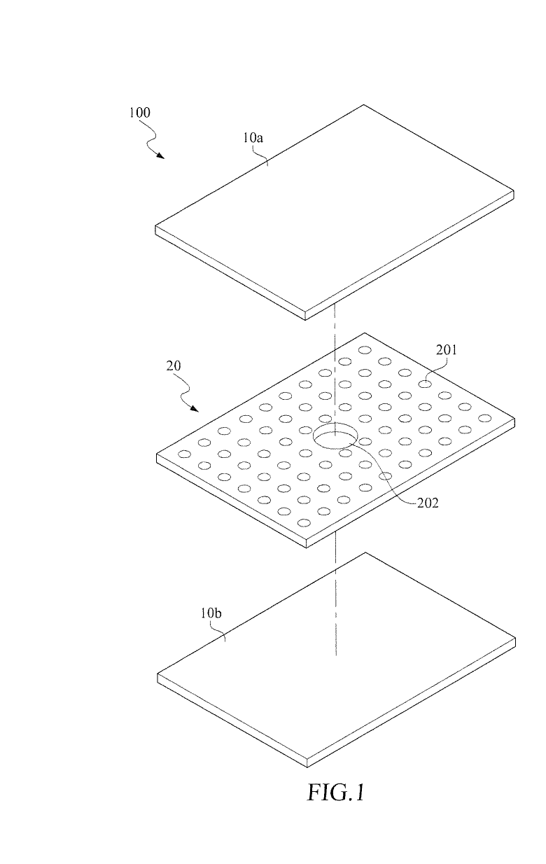

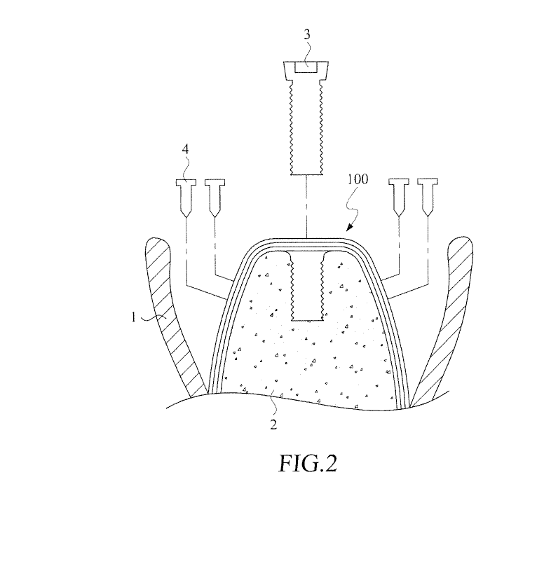

Referring to FIGS. 1 and 2, wherein FIG. 1 is a schematic view of a composite regeneration membrane in accordance with a preferred embodiment of the present invention, and FIG. 2 is a schematic view showing the usage of the composite regeneration membrane in accordance with a preferred embodiment of the present invention. As shown, the composite regeneration membrane 100 of the present invention is utilized for separating the alveolar bone tissue 2 and the gum epithelium tissue 1 (only one of them is labeled). The composite regeneration membrane 100 includes collagen resorbable layers 10a and 10b, and a titanium bendable layer 20.

The collagen resorbable layers 10a and 10b are utilized for transmitting material between the alveolar bone tissue 2 and the gum epithelium tissue 1. The titanium bendable layer 20 is located between the collagen resorbable layers 10a and 10b for supporting the collagen resorbable layers 10a and 10b. The titanium bendable layer 20 also has a plurality of transmitting holes 201 (only one of them is labeled) and a main fixing hole 202. The transmitting holes 201 are utilized for allowing the material transmitted by the collagen resorbable layers 10a and 10b to pass through, the main fixing hole 202 is utilized for allocating a dental implant 3, and a diameter of the main fixing hole 202 is greater than that of the transmitting holes 201.

In addition, an interval of the holes 201 is greater than a predetermined interval for inserting a plurality of bone fixations 4 (only one of them is labeled) between these holes 201 or directly into these holes 201 to have the composite regeneration membrane 100 fixed on the alveolar bone tissue 2 to further enhance the adherence of the composite regeneration membrane 100.

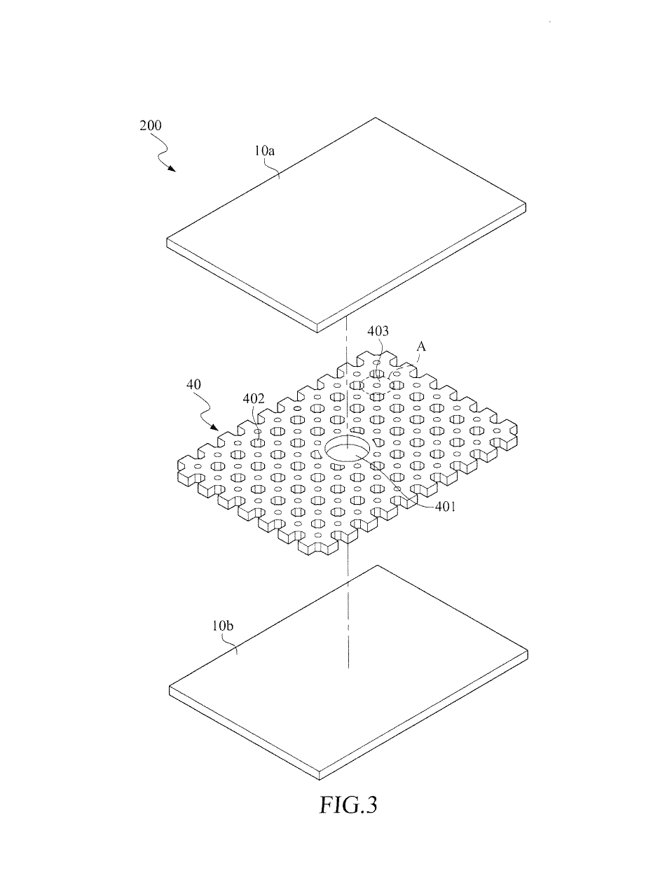

Referring to FIG. 3 in combination with FIG. 2, wherein FIG. 3 shows a composite regeneration membrane in accordance with another preferred embodiment of the present invention. As shown, the disclosed composite regeneration membrane 200 includes collagen resorbable layers 10a and 10b and a titanium bendable net 40.

The collagen resorbable layers 10a and 10b are utilized for transmitting material between the alveolar bone tissue 2 and the gum epithelium tissue 1 a shown in FIG. 2. The titanium bendable net 40 is located in the collagen resorbable layers 10a and 10b for supporting the collagen resorbable layers 10a and 10b.

The titanium bendable net 40 has a main fixing hole 401 and a plurality of meshes 402 (only one of them is labeled) formed therein, and also has a plurality of nodes 403 (only one of them is labeled). A diameter of the main fixing hole 401 is greater than that of the meshes 402. The meshes 402 are utilized for allowing the material transmitted by the collagen resorbable layers 10a and 10b to pass through.

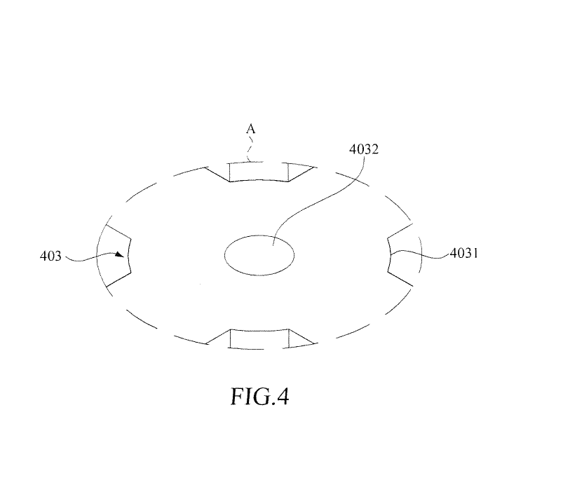

Also referring to FIG. 4, which shows an enlarged view of area A of the composite regeneration membrane 200 in accordance with the present invention. As shown, each node 403 (only one of them is labeled) of the titanium bendable net 40 has a disk-shaped fixing part 4031 and a fixing hole 4032 for allocating a bone fixation 4 there through to have the composite regeneration membrane 200 fixed on the alveolar bone tissue 2.

As mentioned above, the present invention has the titanium bendable layer assembled in the collagen resorbable layer to provide a composite regeneration membrane with rigidity and good biocompatibility for the gum epithelium tissue so as to prevent the wound from being exposed to result in infection. In addition, a good circulation of blood can be maintained through the plural holes formed in the collagen resorbable layer and the titanium bendable layer. Moreover, the bone fixations can be used in the present invention to assist fixation of the composite regeneration membrane so as to keep good stability to have the bone cells adhere thereto. Besides, since the present invention has a main fixing hole formed therein, the space for dental implant can be maintained without the need of second-stage surgery.

The detail description of the aforementioned preferred embodiments is for clarifying the feature and the spirit of the present invention. The present invention should not be limited by any of the exemplary embodiments described herein, but should be defined only in accordance with the following claims and their equivalents. Specifically, those skilled in the art should appreciate that they can readily use the disclosed conception and specific embodiments as a basis for designing or modifying other structures for carrying out the same purposes of the present invention without departing from the scope of the invention as defined by the appended claims.

We claim:

1. A composite regeneration membrane, utilized for separating an alveolar bone tissue and a gum epithelium tissue, comprising:
a collagen resorbable layer, utilized for transmitting material between the alveolar bone tissue and the gum epithelium tissue; and
a titanium bendable layer, located in the collagen resorbable layer for supporting the collagen resorbable layer, and having a plurality of transmitting holes allowing the material transmitted by the collagen resorbable layer to pass through.

2. The composite regeneration membrane of claim 1, wherein the titanium bendable layer further has a main fixing hole for allocating a dental implant, and a diameter of the main fixing hole is greater than that of the transmitting holes.

3. The composite regeneration membrane of claim 1, wherein an interval of the transmitting holes is greater than a predetermined interval for inserting a plurality of bone fixations therebetween to have the composite regeneration membrane fixed on the alveolar bone tissue.

4. A composite regeneration membrane, utilized for separating an alveolar bone tissue and a gum epithelium tissue, comprising:
a collagen resorbable layer, utilized for transmitting material between the alveolar bone tissue and the gum epithelium tissue; and
a titanium bendable net, located in the collagen resorbable layer for supporting the collagen resorbable layer, and meshes of the titanium bendable net allowing the material transmitted by the collagen resorbable layer to pass through.

5. The composite regeneration membrane of claim 4, wherein each node of the titanium bendable net has a fixing part.

6. The composite regeneration membrane of claim 5, wherein the fixing part is disk shaped.

7. The composite regeneration membrane of claim 4, wherein each of the nodes of the titanium bendable net has a fixing hole for allocating a bone fixation to have the composite regeneration membrane fixed on the alveolar bone tissue.

8. The composite regeneration membrane of claim 4, wherein the titanium bendable net further has a main fixing hole for allocating a dental implant, and a diameter of the main fixing hole is greater than that of the meshes.
